(19) United States
(12) Patent Application Publication
(10) Pub. No.: US 2025/0002367 A1
(43) Pub. Date: Jan. 2, 2025

(54) POSITIVE ELECTRODE ACTIVE MATERIAL AND LITHIUM SECONDARY BATTERY INCLUDING THE SAME

(71) Applicants: Hyundai Motor Company, Seoul (KR); Kia Corporation, Seoul (KR); UNIST(ULSAN NATIONAL INSTITUTE OF SCIENCE AND TECHNOLOGY), Ulsan (KR)

(72) Inventors: Je Sik Park, Seoul (KR); Hong-Seok Min, Yongin-si (KR); Sung Woo Noh, Seoul (KR); Jeong Hyun Seo, Daejeon (KR); Chung Bum Lim, Suwon-si (KR); Ju Yeong Seong, Seongnam-si (KR); Im Sul Seo, Cheongju-si (KR); Dong Hwa Seo, Ulsan (KR); Eun Ryeol Lee, Ulsan (KR); Sang Wook Park, Ulsan (KR)

(21) Appl. No.: 18/527,866

(22) Filed: Dec. 4, 2023

(30) Foreign Application Priority Data
Jun. 28, 2023 (KR) 10-2023-0083127

(51) Int. Cl. C01G 45/12; H01M 10/052; H01M 10/44

(52) U.S. Cl. CPC C01G 45/1228; H01M 10/052; H01M 10/44; C01P 2002/08; C01P 2002/32; C01P 2002/72; C01P 2006/40

(57) ABSTRACT

In an embodiment, a cathode active material can include a lithium oxide having a disordered rocksalt (DRX) structure, and the lithium oxide is configured to phase-transform from the DRX structure into a spinel-like structure during charging so as to alleviate and/or prevent rate capability decrease and irreversible voltage drop caused by lithium and manganese existing in excess in the lithium oxide, and a lithium secondary battery embodiment including the same.

### CROSS-REFERENCE TO RELATED APPLICATIONS

This application claims the benefit of Korean Patent Application No. 10-2023-0083127, filed on Jun. 28, 2023, which application is hereby incorporated herein by reference.

### TECHNICAL FIELD

The present disclosure relates to a cathode active material of a lithium secondary battery.

### BACKGROUND

Batteries store electrical power by applying materials that may cause electrochemical reactions to anodes and cathodes. As a representative example of these batteries, there is a lithium secondary battery that stores electrical energy due to a chemical potential difference when a cathode and an anode intercalate and deintercalate lithium ions.

A lithium secondary battery uses materials that enable reversible intercalation and deintercalation of lithium ions as a cathode active material and an anode active material, and is manufactured by filling an organic electrolyte solution or a polymer electrolyte solution between the cathode and the anode.

A lithium oxide is used as the cathode active material of the lithium secondary battery and, as examples of the lithium oxide, LiCoO₂, LiMn₂O₄, LiNiO₂, and LiMnO₂, and a composite oxide including Ni, Co, Mn, or Al, disclosed in Korean Patent Laid-open Publication No. 10-2015-0069334 (Publication Date: Jun. 23, 2015) are being researched.

Among the above cathode active materials, LiCoO₂ has excellent life characteristics and charge efficiency and is thus most commonly used, but is expensive due to the resource limit of cobalt used as a raw material and thus has a limit in terms of price competitiveness.

Lithium manganese oxides, such as LiMnO₂ and LiMn₂O₄, have excellent thermal stability and are low in price, but have drawbacks, such as low capacity and poor high temperature characteristics. Further, LiMnO₂-based cathode active materials exhibit high discharge capacity, but are difficult to synthesize due to cation mixing between Li and a transition metal and thus have a big problem with rate capability.

Further, a large amount of Li by-products is produced depending on the degree of deepening of cation mixing, and most of the Li by-products include a compound of LiOH and Li₂CO₃, and thus the Li by-products are gelled when a cathode paste is manufactured, and cause generation of gas when charging and discharging is progressed after the cathode is manufactured. The remainder of Li₂CO₃ increases swelling of cells, and thus reduces the number of cycles for the battery and causes swelling of the battery.

Various candidate materials to make up for the drawbacks of the conventional cathode active material are being discussed.

As one example, research on use of a lithium manganese-based oxide, which includes an excess of Mn among transition metals and an excess of lithium, which is greater than the sum total of the amounts of the transition metals, as a cathode active material for lithium secondary batteries is underway. Such a lithium manganese-based oxide including the excess of lithium may be referred to as an over-lithiated layered oxide (OLO).

The OLO theoretically exhibits high capacity under a high-voltage operating environment, but has a relatively low electrical conductivity due to the excess of Mn included in the oxide and is thus disadvantageous in that a lithium secondary battery using the OLO has low rate capability. When the rate capability is low, charge and discharge capacities and life efficiency (i.e., capacity retention) of the lithium secondary battery during cycling are reduced.

As another example to make up for the drawbacks of the conventional cathode active materials, research on a lithium oxide having a disordered rocksalt (DRX) structure, in which large anions are arranged to be piled up most densely, all octahedral sites are occupied by cations, and the anions and the cations are alternately arranged, is underway.

In general, the DRX structure was not widely used as a cathode active material because Li ions were not easily diffused, but it is revealed that, when an excess, i.e., a sufficient amount, of Li is provided to the DRX structure, Li diffusion (O-TM) channels are increased, and thus the DRX is usable as a high-capacity cathode active material.

However, in a Li rich composite oxide having the above DRX structure, an excess of oxygen participates in the charging and discharging process, oxygen is separated from a lattice structure, pores are formed, inner resistance is increased, and thereby, Li diffusion capacity may be reduced. Such reduction in the Li diffusion capacity may serve as a main reason to cause reduction in charge and discharge capacities and irreversible voltage drop during cycling.

In order to solve the above problems, there is an attempt to alleviate and suppress loss of oxygen by doping a lattice provided with oxygen anions with fluorine (F) which forms stronger ionic bonds than oxygen, but this method is not up to the level of commercialization.

The above information disclosed in this Background section is only for enhancement of understanding of the background of the present disclosure and therefore it may contain information that does not form the prior art that is already publicly known.

### SUMMARY

The present disclosure relates to a cathode active material and a lithium secondary battery including the same. More particularly, the present disclosure relates to a cathode active material including a lithium oxide having a disordered rocksalt (DRX) structure that is phase-transformed from the DRX structure into a spinel-like structure when charging so as to alleviate and/or prevent rate capability decrease and irreversible voltage drop caused by lithium and manganese existing in excess in the lithium oxide, and a lithium secondary battery including the same.

The lithium secondary battery market is driven by growth of lithium secondary batteries for electric vehicles, and demand for cathode active materials used in the lithium secondary batteries is consistently changed also.

For example, lithium secondary batteries using lithium iron phosphate (LFP) have been mainly used conventionally in terms of safety assurance, but use of nickel-based lithium oxides having high energy capacity per weight compared to LFP is expanding now.

Further, most nickel-based lithium oxides recently used as cathode active materials of high-capacity lithium secondary batteries essentially use ternary metal elements, such as nickel, cobalt and manganese, or nickel, cobalt and aluminum, and there among, cobalt is unstable in supply and demand and is excessively expensive compared to other raw materials. And thus, a cathode active material having a new composition in which the content of cobalt is reduced or cobalt is excluded is desired or required.

In this respect, a lithium oxide having a disordered rocksalt (DRX) structure may live up to expectations of the above-described market, but typically does not provide sufficient electrochemical characteristics or stability to replace a commercialized NCM or NCA-type cathode active material.

The present disclosure has been made in an effort to solve the above-described problems, and an embodiment of the present disclosure can provide a cathode active material that may alleviate and/or prevent deterioration of electrochemical characteristics of a lithium oxide having the conventional disordered rocksalt (DRX) structure when charging and discharging.

Particularly, an embodiment of the present disclosure can provide a cathode active material that may control a degree of phase transformation of the lithium oxide from the disordered rocksalt (DRX) structure into a spinel-like structure when charging and discharging.

An embodiment of the present disclosure can provide a cathode including a cathode active material defined in the present disclosure. An embodiment of the present disclosure can provide a lithium secondary battery using a cathode defined in the present disclosure.

In an embodiment of the present disclosure, a cathode active material can include a lithium oxide configured to enable intercalation and deintercalation of lithium, wherein the lithium oxide is represented by following Formula 1, and configured such that at least a part of the lithium oxide is phase-transformed from a disordered rocksalt structure into a spinel-like structure when charging, at least a part of the lithium oxide is phase-transformed from the spinel-like structure to the DRX structure when discharging, the disordered rocksalt structure and the spinel-like structure are mixed in a charged state, and at least the disordered rocksalt structure exists in a discharged state:

[Formula 1]

Li_{1.05-x}Mn_{0.95-y}M_{y}O_{2-z}F_{z}

wherein, M is can be Ti, Al, Nb, Mo, V, Cr, Mg, or any combination thereof, and wherein 0≤x≤0.5, 0≤y≤0.45, and 0<z≤0.6.

In an embodiment, as a content of Mn in the lithium oxide increases, a degree of phase transformation when charging may be increased.

In an embodiment, as a result of XRD analysis of the lithium oxide when charging, a diffraction peak corresponding to a (111) plane derived from the spinel-like structure may be observed.

In an embodiment, the diffraction peak may occur at a diffraction angle 2θ of 18° to 19°.

In an embodiment, y may be 0.19 or less. For example, the lithium oxide may be Li_{1.05}Mn_{0.76}Ti_{0.19}O_{1.8}F_{0.2}.

In an embodiment, when charging and discharging of a lithium secondary battery using the cathode active material in a cathode are performed under following charge/discharge conditions, voltage loss in a 30th cycle may be 5.9% or less:

### [Charge/Discharge Conditions]

One cycle:
Cut-off voltage: 1.5 V-4.8 V
Constant current: 40 mA/g.

In an embodiment, when a lithium secondary battery using the cathode active material in a cathode is initially charged at a voltage of 4.6 V, a phase transformation rate calculated through a two-phase model based on Rietveld refinement of X-ray diffraction patterns may be 3.4% to 18%.

In an embodiment, a phase transformation rate from the disordered rocksalt structure into the spinel-like structure, when charging, may be equal to or greater than a phase transformation rate from the spinel-like structure into the disordered rocksalt structure when discharging.

In an embodiment, y may be 0.05 or less. For example, the lithium oxide may be Li_{1.05}Mn_{0.90} Ti_{0.05}O_{1.8}F_{0.2}.

In an embodiment, when charging and discharging of a lithium secondary battery using the cathode active material in a cathode are performed under following charge/discharge conditions, voltage loss in a 30th cycle may be 1.8% or less:

### [Charge/Discharge Conditions]

One cycle:
Cut-off voltage: 1.5 V-4.8 V
Constant current: 40 mA/g.

In an embodiment, when a lithium secondary battery using the cathode active material in a cathode is initially charged at a voltage of 4.6 V, a phase transformation rate calculated through a two-phase model based on Rietveld refinement of X-ray diffraction patterns may be 14% to 18%.

In an embodiment, a phase transformation rate from the disordered rocksalt structure into the spinel-like structure, when charging, may exceed a phase transformation rate from the spinel-like structure into the disordered rocksalt structure when discharging.

In an embodiment, when charging and discharging of a lithium secondary battery using the cathode active material in a cathode are performed under following charge/discharge conditions, the lithium secondary battery may have flat potential characteristics at 3 V and 4 V in a graph configured such that an X-axis represents specific capacity and a Y-axis represents voltage (V):

### [Charge/Discharge Conditions]

One cycle:
Cut-off voltage: 1.5 V-4.8 V
Constant current: 40 mA/g.

In an embodiment of the present disclosure, a cathode can include the above-described cathode active material. In an embodiment of the present disclosure, a lithium secondary battery can include the above-described cathode.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not necessarily limitative of the present disclosure, and wherein:

FIG. 1 shows results of X-ray diffraction (XRD) of a cathode active material embodiment according to Example 1, measured at different voltages;

FIG. 2 shows results of XRD of a cathode active material embodiment according to Example 2, measured at different voltages;

FIG. 3 shows results of XRD of the cathode active material embodiment according to Example 1, measured while repeating a charge-discharge cycle;

FIG. 4 shows results of XRD of the cathode active material embodiment according to Example 2, measured while repeating the charge-discharge cycle;

FIG. 5 shows discharge curves of the cathode active material embodiment according to Example 1, measured at different discharge rates;

FIG. 6 shows discharge curves of the cathode active material embodiment according to Example 2, measured at different discharge rates;

FIG. 7 shows charge-discharge cycle curves of the cathode active material embodiment according to Example 1;

FIG. 8 shows charge-discharge cycle curves of the cathode active material embodiment according to Example 2; and

FIG. 9 shows voltage conservation characteristics of cathode active material embodiments according to Examples and a Comparative Example.

It can be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, can be determined in part by the particular intended application and use environment.

In the figures, reference numbers refer to same or equivalent parts of the present disclosure throughout the several figures of the drawing.

### DETAILED DESCRIPTION OF ILLUSTRATIVE EMBODIMENTS

The above-described advantages and features, and other advantages and features, of the present disclosure can become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, terms, such as “including”, “comprising” and “having”, are to be interpreted as indicating the presence of characteristics, numbers, steps, operations, elements, or parts stated in the description, or combinations thereof, and do not exclude the presence of one or more other characteristics, numbers, steps, operations, elements, parts, or combinations thereof, or possibility of adding the same. In addition, it can be understood that, when a part, such as a layer, a film, a region, or a plate, is said to be “on” another part, the part may be located “directly on” the other part or other parts may be interposed between the two parts. In the same manner, it can be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected and thus it can be understood that they can be modified by the term “about”, unless stated otherwise. In addition, it can be understood that, if a numerical range is disclosed in the description, such a range includes all continuous values from a minimum value to a maximum value of the range, unless stated otherwise. Further, if such a range refers to integers, the range can include all integers from a minimum integer to a maximum integer, unless stated otherwise.

Hereinafter, a lithium oxide according to an embodiment of the present disclosure, at least a part of which is phase-transformed from a disordered rocksalt (DRX) structure into a spinel-like structure when charging, and a cathode active material including the lithium oxide will be described in detail.

### Cathode Active Material

In an embodiment of the present disclosure, a cathode active material can include a lithium oxide enabling intercalation and deintercalation of lithium, and can be configured such that at least a part of the lithium oxide is phase-transformed from the disordered rocksalt (DRX) structure into the spinel-like structure when charging, at least a part of the lithium oxide is phase-transformed from the spinel-like structure to the DRX structure when discharging, the DRX structure and the spinel-like structure are mixed in a charged state, and at least the DRX structure exists in a discharged state.

The lithium oxide may be an oxide that may store and release lithium ions, and may include lithium ions and a metal element, and particularly, the lithium oxide used in an embodiment of the present disclosure may be a lithium manganese-based oxide including lithium and manganese. Concretely, the lithium oxide may be represented by Formula 1 below:

[Formula 1]

Li_{1.05-x}Mn_{0.95-y}M_{y}O_{2-z}F_{z}

wherein M can be Ti, Al, Nb, Mo, V, Cr, Mg, or any combination thereof, and wherein 0≤x≤0.5, 0≤y≤0.45, and 0<z≤0.6.

The lithium oxide may have the DRX structure as a crystal structure before initial charging is performed. The DRX structure may indicate an energetically stabilized rocksalt structure in which various types of transition metal elements are randomly mixed with a host lattice enabling intercalation and deintercalation of lithium ions.

The lithium ions may provide the lowest energy barrier in the lithium oxide having the DRX structure, and may migrate through Oxygen-Transition Metal (O-TM) channels, which promotes Li diffusion. The O-TM channels may be more easily formed in case of a lithium rich oxide, but the lithium oxide is not necessarily a lithium rich oxide.

In a lithium oxide having a DRX structure, with an excess of oxygen participates in a charging and discharging process, oxygen can be separated from a lattice structure, pores can be formed, inner resistance can be increased, and thereby, Li diffusion capacity may be reduced.

Referring to Formula 1 above, in a cathode active material according to an embodiment of the present disclosure, loss of oxygen may be alleviated or suppressed by doping the lattice provided with oxygen anions with fluorine (F) which forms stronger ionic bonds than oxygen. Thereby, generation of pores and increase in inner resistance due to separation of oxygen may be suppressed, and retention of Li diffusion capacity may be improved.

At least a part of the lithium oxide may be phase-transformed from the DRX structure into the spinel-like structure when charging. And by at least a part of the lithium oxide may be phase-transformed from the DRX structure into the spinel-like structure, rate capability and battery life characteristics may be improved. Particularly, irreversible voltage drop when charging and discharging may be alleviated.

Improvement in electrochemical characteristics and life characteristics depending on phase transformation may be caused by improvement in Li ion diffusion capacity due to increase in the O-TM channels because of phase transformation of at least a part of the lithium oxide from the DRX structure into the spinel-like structure.

The above-described spinel-like structure may be different from a conventional spinel structure in which tetrahedral (Td)-8a sites and octahedral (Oh)-16d sites are occupied by Li and a transition metal, respectively, in that Td-8a sites are disorderedly occupied by a transition metal in the spinel-like structure.

As such, at least a part of the lithium oxide may be phase-transformed from the DRX structure into the spinel-like structure when charging, and therefore, the DRX structure and the spinel-like structure may be mixed or coexist in the charged state.

Further, at least a part of the lithium oxide may be phase-transformed from the spinel-like structure into the DRX structure when discharging. Therefore, the ratio of the spinel-like structure in the lithium oxide in the discharged state may be less than the ratio of the spinel-like structure in the lithium oxide in the charged state.

Such phase transformation from the DRX structure into the spinel-like structure may be reversible and/or irreversible. Any one of the reversible phase transformation and the irreversible phase transformation may not be necessarily selectively performed, and both of the reversible phase transformation and the irreversible phase transformation may be performed simultaneously.

When the phase transformation is reversible, all of the lithium oxide having the spinel-like structure generated when charging may be phase-transformed into the DRX structure during the discharging process. That is, a phase transformation rate of the lithium oxide from the DRX structure into the spinel-like structure when charging and a phase transformation rate of the lithium oxide from the spinel-like structure into the DRX structure when discharging may be the same.

Therefore, the lithium oxide may have the DRX structure in the discharged state.

When the phase transformation is irreversible, only a part of the lithium oxide having the spinel-like structure generated when charging may be phase-transformed into the DRX structure during the discharging process. That is, the phase transformation rate of the lithium oxide from the DRX structure into the spinel-like structure when charging may be greater than the phase transformation rate of the lithium oxide from the spinel-like structure into the DRX structure when discharging.

Therefore, the lithium oxide in the discharged state may be in a state in which the DRX structure and the spinel-like structure can be mixed.

Further, when irreversible phase transformation occurs, the ratio of the spinel-like structure in the lithium oxide may be gradually increased due to repetitions of the charge and discharge cycle. Therefore, in the charge and discharge cycle of the lithium oxide including irreversible phase transformation, discharge voltage may be increased in initial cycles (for example, in initial 10 or fewer cycles).

In an embodiment, as the amount of Mn in the lithium oxide increases, a degree of phase transformation when charging may be increased. Therefore, the ratio of the spinel-like structure in the lithium oxide may be increased in the charged state.

Further, according to an embodiment of the present disclosure, the degree of phase transformation from the DRX structure into the spinel-like structure may be controlled by adjusting the ratio of Mn in the lithium oxide, and thereby, electrochemical characteristics and life characteristics of the cathode active material including the lithium oxide may be improved.

In addition, as the amount of Mn in the lithium oxide increases, the rate of irreversible phase transformation may be increased.

In an embodiment, a diffraction peak corresponding to the (111) plane derived from the spinel-like structure may be observed as results of XRD analysis of the lithium oxide when charging. Here, the diffraction peak may occur at a diffraction angle 2θ of 18° to 19°, for example.

The diffraction peak may be derived from phase transformation from the DRX structure into the spinel-like structure occurring when charging. Therefore, the intensity of the diffraction peak may be increased as the ratio of the spinel-like structure is increased.

Further, as the charge and discharge voltages of a secondary battery including the cathode active material are increased or the charge-discharge cycle of the secondary battery is increased, the ratio of the spinel-like structure in the lithium oxide can be increased and thus the intensity of the diffraction peak may be increased.

In an embodiment, y may be 0.19 or less. That is, the composition ratio of Mn in the lithium oxide may be 0.76 or more.

In the composition range in which y is 0.19 or less, the phase transformation rate from the DRX structure into the spinel-like structure when charging the active material including the lithium oxide may be equal to or greater than the phase transformation rate from the spinel-like structure into the DRX structure when discharging.

When the phase transformation rate from the DRX structure into the spinel-like structure when charging and the phase transformation rate from the spinel-like structure into the DRX structure when discharging are the same, the phase transformation from the DRX structure into the spinel-like structure may be reversible.

When the phase transformation rate from the DRX structure into the spinel-like structure when charging is greater than the phase transformation rate from the spinel-like structure into the DRX structure when discharging, the phase transformation from the DRX structure into the spinel-like structure may be irreversible.

As such, as y is 0.19 or less, the phase transformation may reversibly occur, or may include irreversible phase transformation. Here, the rate of the irreversible phase transformation may be increased as the content of Mn included in the lithium oxide increases.

In an embodiment, when charging and discharging of a lithium secondary battery using the cathode active material having the composition range, in which y is 0.19 or less, in a cathode are performed under the following charge/discharge conditions, voltage loss in the 30th cycle may be 5.9% or less:

### [Charge/Discharge Conditions]

One cycle:
Cut-off voltage: 1.5 V-4.8 V
Constant current: 40 mA/g.

As at least a part of the lithium oxide can be phase-transformed from the DRX structure into the spinel-like structure when charging, voltage conservation characteristics of the cathode active material according to the present disclosure may be improved.

In an embodiment, when the lithium secondary battery using the cathode active material having y of 0.19 or less as the cathode is initially charged at a voltage of 4.6 V, the phase transformation rate of the lithium oxide from the DRX structure into the spinel-like structure may be 3.4% to 18%. Particularly, the phase transformation rate may be 5.4% to 16%. Here, the phase transformation rate may be calculated by employing a two-phase model based on Rietveld refinement of X-ray diffraction patterns (XRD refinement) of the cathode active material in a pristine state and the cathode active material charged at a voltage of 4.6 V.

When the phase transformation rate of the lithium oxide from the DRX structure into the spinel-like structure is less than 3.4%, additional O-TM channel generation effects caused by formation of the spinel-like structure may be excessively low.

In an embodiment, y may be 0.05 or less. That is, the composition ratio of Mn in the lithium oxide may be 0.90 or more.

In the composition range in which y is 0.05 or less, the phase transformation rate from the DRX structure into the spinel-like structure when charging the cathode active material including the lithium oxide may exceed the phase transformation rate from the spinel-like structure into the DRX structure when discharging. That is, the phase transformation from the DRX structure into the spinel-like structure may include irreversible phase transformation.

In the cathode active material in which y is 0.05 or less, at least a part of the phase transformation from the DRX structure into the spinel-like structure is irreversibly performed, and thus the DRX structure and the spinel-like structure may be mixed even in the discharged state.

In an embodiment, when charging and discharging of a lithium secondary battery using the cathode active material having the composition range, in which y is 0.05 or less, in a cathode are performed under the following charge/discharge conditions, voltage loss in the 30th cycle may be 1.8% or less:

### [Charge/Discharge Conditions]

One cycle:
Cut-off voltage: 1.5 V-4.8 V
Constant current: 40 mA/g.

As at least a part of the lithium oxide can be phase-transformed from the DRX structure into the spinel-like structure when charging, voltage conservation characteristics of the cathode active material according to the present disclosure may be improved.

Particularly, in the cathode active material having the composition range, in which y is 0.05 or less, a larger amount of the phase transformation into the spinel-like structure can occur than in the cathode active material having the composition range, in which y exceeds 0.05, and thus, rate capability and voltage conservation characteristics may be more improved.

In an embodiment, when the lithium secondary battery using the above cathode active material is initially charged at a voltage of 4.6 V, the phase transformation rate of the lithium oxide from the DRX structure into the spinel-like structure calculated through a two-phase model based on Rietveld refinement of X-ray diffraction patterns (XRD refinement) may be 14% to 18%.

Further, the phase transformation rate is directly proportional to the initial charging voltage. Further, as the charge-discharge cycle is repeated, the phase transformation rate into the spinel-like structure may be increased due to irreversible phase transformation.

In an embodiment, when charging and discharging of the lithium secondary battery using the cathode active material in a cathode are performed under the following charge/discharge conditions, the lithium secondary battery may have flat potential characteristics at 3 V and 4 V in a graph in which the X-axis represents specific capacity and the Y-axis represents voltage (V):

### [Charge/Discharge Conditions]

One cycle:
Cut-off voltage: 1.5 V-4.8 V
Constant current: 40 mA/g.

The flat potential characteristics may be observed in a cathode active material including the spinel-like structure. That is, the flat potential characteristics observed after charging and discharging were performed may be derived from irreversible phase transformation in which the spinel-like structure exists even after charging and discharging. Therefore, the flat potential characteristics may not be observed in a cathode active material in which only reversible phase transformation occurs.

Further, as the charge-discharge cycle of the cathode active material is repeated, the flat potential characteristics may be more prominent due to increase in the amount of the spinel-like structure caused by irreversible phase transformation.

### Lithium Secondary Battery

Further, according to an embodiment of the present disclosure, a cathode including the above-described cathode active material is provided. The cathode including a cathode current collector and a cathode active material layer formed on the cathode current collector may be provided. Here, the cathode active material layer may include any one of the lithium oxides according to various embodiments of the present disclosure as the cathode active material.

Therefore, a detailed description of the lithium oxide will be omitted, and other elements, which have not been described above, will be described hereinafter. Further, for convenience, the above-described lithium oxide will be referred to as the cathode active material.

The cathode current collector may be any material which has conductivity without causing chemical change of a battery, without being limited thereto, and may include, for example, stainless steel, aluminum, nickel, titanium, baked carbon, or aluminum or stainless steel which is surface-treated with carbon, nickel, titanium, silver, or the like. Further, the cathode current collector may generally have a thickness of 3 to 500 μm, and micro-irregularities may be formed on the surface of the cathode current collector so as to increase adhesive strength of the cathode active material to the cathode current collector. For example, the cathode current collector may be provided in various types, such as a film, a sheet, foil, a net, a porous body, a foamed body, an unwoven fabric, and the like.

The cathode active material layer may be manufactured by applying a cathode slurry composition including the cathode active material and a conductive material, and selectively including a binder, if necessary, to the cathode current collector.

Here, the cathode active material layer may include 80 to 99 wt %, or more particularly, 85 to 98.5%, of the cathode active material with respect to the total weight of the cathode active material layer. The cathode active material layer may exhibit excellent capacity characteristics, when the content of the cathode active material is in the above range, without being limited thereto.

The conductive material serves to provide conductivity to the cathode, and may include any material that has electronic conductivity without causing chemical change of the cathode, without being limited thereto. For example, the conductive material may be graphite such as natural graphite or artificial graphite, a carbon-based material such as carbon black, acetylene black, Ketjen black, channel black, furnace black, lamp black, summer black, or carbon fibers, metal powder or metal fibers, such as copper, nickel, aluminum, or silver, a conductive whisker such as zinc oxide or potassium titanate, a conductive metal oxide such as titanium oxide, or a conductive polymer such as a polyphenylene derivative, and any one of the above-described substances may be used alone or a mixture of two or more thereof may be used. The conductive material may be included in an amount of 0.1 to 15 wt % with respect to the total weight of the cathode active material layer.

The binder may serve to improve binding among cathode active material particles and adhesive strength between the cathode active material and the cathode current collector. For example, the binder may be polyvinylidene fluoride (PVDF), polyvinylidene fluoride-co-hexafluoropropylene (PVDF-co-HFP), polyvinyl alcohol, polyacrylonitrile, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated EPDM, styrene-butadiene rubber (SBR), fluoro rubber, or copolymers thereof, and any one of the above-described substances may be used alone or a mixture of two or more thereof may be used. The binder may be included in an amount of 0.1 to 15 wt % with respect to the total weight of the cathode active material layer.

The cathode may be manufactured by a general cathode manufacturing method except that the above-described cathode active material is used. For example, the cathode may be manufactured by applying a cathode slurry composition, prepared by dissolving or dispersing the above-described cathode active material and selectively the binder and the conductive material in a solvent, to the cathode current collector, and drying and rolling the cathode current collector having the cathode slurry composition applied thereto.

The solvent may be a solvent that is generally used in the technical field to which the present disclosure pertains, and may be dimethyl sulfoxide (DMSO), isopropyl alcohol, N-methyl pyrrolidone (NMP), acetone, or water, and any one of the above-described substances may be used alone or a mixture of two or more thereof may be used. The amount of the solvent used to have viscosity enough to dissolve or disperse the cathode active material, the conductive material and the binder therein in consideration of the application thickness and manufacturing yield of the slurry and to exhibit excellent thickness uniformity when the slurry is applied to the cathode current collector to manufacture the cathode is sufficient.

Further, in an embodiment, the cathode may be manufactured by casting the cathode slurry composition on a separate support and laminating a film peeled from the support on the cathode current collector.

In addition, according to an embodiment of the present disclosure, an electrochemical device including the above-described cathode may be provided. The electrochemical device may be a battery, a capacitor, or the like, and for example, may be a lithium secondary battery.

For example, the lithium secondary battery may include the cathode, an anode located opposite to the cathode, and a separator and an electrolyte interposed between the cathode and the anode. Here, the cathode has been described above, and thus a detailed description thereof will be omitted and remaining elements, which have not been described above, will be described in detail.

The lithium secondary battery may further include a battery case configured to receive an electrode assembly including the cathode, the anode and the separator, and a sealing member configured to seal the battery case.

The anode may include an anode current collector, and an anode active material layer located on the anode current collector.

The anode current collector may be any material that has high conductivity without causing chemical change of a battery, without being limited thereto, and may include, for example, copper, stainless steel, aluminum, nickel, titanium, baked carbon, or copper or stainless steel which is surface-treated with carbon, nickel, titanium, silver, or the like, or an aluminum-cadmium alloy. Further, the anode current collector may generally have a thickness of 3 to 500 μm, and micro-irregularities may be formed on the surface of the anode current collector so as to increase adhesive strength of the anode active material to the anode current collector, in the same manner as the cathode current collector. For example, the anode current collector may be provided in various types, such as a film, a sheet, foil, a net, a porous body, a foamed body, an unwoven fabric, and the like.

The anode active material layer may be manufactured by applying an anode slurry composition including the anode active material and a conductive material, and selectively including a binder, if necessary, to the anode current collector.

A compound enabling reversible intercalation and deintercalation of lithium may be used as the anode active material. For example, the anode active material may be a carbonaceous material such as artificial graphite, natural graphite, graphitized carbon fibers, or amorphous carbon, a metallic compound which is alloyable with lithium, such as Si, Al, Sn, Pb, Zn, Bi, In, Mg, Ga, Cd, an Si alloy, an Sn alloy, or an Al alloy, a metal compound into and from which is capable of doping and dedoping lithium, such as SiO_{β}(0<β<2), SnO₂, a vanadium oxide, or a lithium vanadium oxide, or a compound including the metallic compound and the carbonaceous material, such as an Si—C compound or an Sn—C compound, and any one of the above-described substances may be used alone or a mixture of two or more thereof may be used. Further, a metallic lithium thin film may be used as the anode active material. Further, low crystalline carbon, high crystalline carbon, or the like may be used as the carbonaceous material. The low crystalline carbon representatively includes soft carbon or hard carbon, and the high crystalline carbon representatively includes amorphous, plate-shaped, flake-shaped, spherical or fibrous natural graphite or artificial graphite, Kish graphite, pyrolytic carbon, mesophase pitch-based carbon fibers, meso-carbon microbeads, mesophase pitches, or high-temperature baked carbon such as petroleum or coal tar pitch derived cokes.

The anode active material may be included in an amount of 80 to 99 wt % of with respect to the total weight of the anode active material layer.

The binder may be a component that helps binding among the conductive material, the anode active material, and the anode current collector, and may be generally added in an amount of 0.1 to 10 wt % with respect to the total weight of the anode active material layer. For example, the binder may include at least one selected from the group consisting of polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated EPDM, styrene-butadiene rubber (SBR), nitrile butadiene rubber, fluoro rubber, and various copolymers thereof.

The conductive material may be a component which further improves conductivity of the anode active material, and may be added in an amount of 10 wt % or less, particularly, 5 wt % or less, with respect to the total weight of the anode active material layer. The conductive material may include any material which has conductivity without causing chemical change of the anode, without being limited thereto, and may include, for example, graphite such as natural graphite or artificial graphite, carbon black such as acetylene black, Ketjen black, channel black, furnace black, lamp black, or thermal black, conductive fibers such as carbon fibers or metal fibers, metal powder such as fluorinated carbon, aluminum, or nickel powder, a conductive whisker such as zinc oxide or potassium titanate, a conductive metal oxide such as titanium oxide, or a conductive material such as a polyphenylene derivative.

In an embodiment, the anode active material layer may be manufactured by applying an anode slurry composition, prepared by dissolving or dispersing the anode active material and selectively the binder and the conductive material in a solvent, to the anode current collector and drying the anode slurry composition.

In an embodiment, the anode active material layer may be manufactured by casting the anode slurry composition on a separate support and laminating a film peeled from the support on the anode current collector.

In the lithium secondary battery, the separator separates the anode and the cathode from each other and provides lithium ion transfer channels, and may use any material which is generally used in separators of lithium secondary batteries, without being necessarily limited thereto, particularly, a material which has low resistance to transfer of ions of the electrolyte and excellent electrolyte wetting ability. The separator may use a porous polymer film, for example, a porous polymer film manufactured of a polyolefin-based polymer, such as an ethylene homopolymer, a propylene homopolymer, an ethylene-butene copolymer, an ethylene-hexene copolymer, or an ethylene-methacrylate copolymer, or a stack structure having two or more layers thereof. Further, the separator may use a general porous nonwoven fabric, for example, a nonwoven fabric formed of high melting point glass fibers, polyethylene terephthalate fibers, or the like. Moreover, to secure thermal resistance and mechanical strength, a coated separator including a ceramic component and a polymeric material may be used, and the coated separator may be provided in a single-layered structure or a multilayered structure, selectively.

Further, the electrolyte used in the present disclosure may include an organic liquid electrolyte, an inorganic liquid electrolyte, a solid polymer electrolyte, a gel-type polymer electrolyte, an inorganic solid electrolyte, a molten inorganic electrolyte, or the like, which may be used to manufacture lithium secondary batteries, without necessarily being limited thereto.

For example, the electrolyte may include an organic solvent and lithium salt.

The organic solvent may use any material that may serve as a medium through which ions participating to electrochemical reactions of the lithium secondary battery may move, without being limited to a specific material. For example, as the organic solvent, an ester-based solvent such as methyl acetate, ethyl acetate, γ-butyrolactone, or ε-caprolactone, an ether-based solvent, such as dibutyl ether or tetrahydrofuran, a ketone-based solvent such as cyclohexanone, an aromatic hydrocarbon-based solvent such as benzene or fluorobenzene, a carbonate-based solvent such as dimethylcarbonate (DMC), diethylcarbonate (DEC), methylethylcarbonate (MEC), ethylmethylcarbonate (EMC), ethylene carbonate (EC), or propylene carbonate (PC), an alcohol-based solvent such as ethyl alcohol or isopropyl alcohol, nitrile such as R—CN (R being a hydrocarbon group having a linear, branched or ring-shaped structure having 2 to 20 carbons, and including an aromatic ring having double bonds or ether bonds), amide such as dimethylformamide, dioxolane such as 1,3-dioxolane, or sulfolane, may be used. There among, a carbonate-based solvent is preferably used, and a mixture of a cyclic carbonate-based compound (for example, ethylene carbonate or propylene carbonate) having high ionic conductivity and a high dielectric constant which may raise the charge and discharge performance of the lithium secondary battery and a linear carbonate-based compound having low viscosity (for example, ethylmethylcarbonate, dimethylcarbonate, or diethylcarbonate), can be used. In this case, the cyclic carbonate-based compound and the linear carbonate-based compound may be mixed in a volume ratio of about 1:1 to about 1:9 so as to exhibit excellent performance of the electrolyte.

The lithium salt may use any compound that may provide lithium ions used in the lithium secondary battery, without necessarily being limited to a specific compound. For example, the lithium salt may use LiPF₆, LiClO₄, LiAsF₆, LiBF₄, LiSbF₆, LiAlO₄, LiAlClA, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂. The lithium salt may be used in a concentration of 0.1 to 2.0 M. When the concentration of the lithium salt is within the above range, the electrolyte can have proper conductivity and viscosity and may thus exhibit excellent electrolyte performance, and lithium ions may effectively move through the electrolyte.

In addition to the above components of the electrolyte, the electrolyte may further include one or more kinds of additives, for example, a haloalkylene carbonate-based compound such as difluoroethylene carbonate, pyridine, triethylphosphite, triethanolamine, cyclic ether, ethylene diamine, n-glyme, hexaneintriamide, nitrobenzene derivatives, sulfur, a quinoneimine dye, N-substituted oxazolidinone, N,N-substituted imidazolidine, ethylene glycol diethyl ether, ammonium salts, pyrrole, 2-methoxy ethanol, and aluminum trichloride, to improve life characteristics of the battery, suppress reduction in specific capacity, and improve discharge capacity of the battery. The additives may be included in an amount of 0.1 to 5 wt % with respect to the total weight the electrolyte.

The lithium secondary battery including the above-described cathode active material according to an embodiment of the present disclosure can stably exhibit excellent discharge capacity, output characteristics, and life characteristics, and thus can be useful in the field of portable devices such as mobile phones, notebook computers, and digital cameras, and the field of electric vehicles such as hybrid electric vehicles (HEVs).

The appearance of the lithium secondary battery according to an embodiment of the present disclosure may be a cylindrical type using a can, a prismatic type, a pouch type, or a coin type, without being limited to a specific type. Further, the lithium secondary battery may be used as battery cells used as power sources of small devices, and may be used as unit cells in medium and large battery modules including a plurality of battery cells.

According to an embodiment of the present disclosure, a battery module including the lithium secondary battery as a unit cell and/or a battery pack including the same may be provided.

The battery module or the battery pack may be used as a power source of at least one medium or large device out of power tools, electric vehicles (EVs) including hybrid electric vehicles (HEVs) and plug-in hybrid electric vehicle (PHEVs), and power storage systems.

### Manufacturing Example 1. Manufacture of Cathode Active Material

### Example 1

In an embodiment (referred to as Example 1), a cathode active material including a lithium oxide having a composition of Li_{1.05}Mn_{0.90}Ti_{0.05}O_{1.8}F_{0.2} (referred to hereinafter as M₉₀F₂₀) was synthesized by mixing and grinding 0.20 g of Li₂O₂, 0.05 g of Li₂O, 0.04 g of TiO₂, 0.10 g of MnF₂, and 0.61 g of MnO in a solid phase using a high energy ball mill (RETSCH PM-200, R1=0.0785 m) at a speed of 500 rpm for 40 hours.

### Example 2

In an embodiment (referred to as Example 2), a cathode active material including a lithium oxide having a composition of Li_{1.05}Mn_{0.76}Ti_{0.19}O_{1.8}F_{0.2} (referred to hereinafter as M₇% F₂₀) was synthesized by mixing and grinding 0.13 g of Li₂O₂, 0.10 g of Li₂O, 0.17 g of TiO₂, 0.10 g of MnF₂, and 0.51 g of MnO in a solid phase using the high energy ball mill (RETSCH PM-200, R1=0.0785 m) at a speed of 500 rpm for 40 hours.

### Comparative Example 1

In an embodiment (referred to as Comparative Example 1), a cathode active material including a lithium oxide having a composition of Li_{1.2}Mn_{0.4}Ti_{0.4}O₂ (referred to hereinafter as M₄₀F₀) was synthesized through the same process as in Example 1, except that 0.12 g of Li₂O₂, 0.15 g of Li₂O, 0.39 g of TiO₂, and 0.35 g of MnO were used and MnF₂ was not used.

### Manufacturing Example 2. Manufacture of Lithium Secondary Battery

In an embodiment, a cathode slurry was prepared by dispersing 90 wt % of each of the cathode active materials manufactured according Manufacturing Example 1, 5.5 wt % of carbon black, and 4.5 wt % of PVDF as a binder in 30 g of N-methyl-2-pyrrolidone (NMP). In an embodiment, a cathode for lithium secondary batteries was manufactured by uniformly applying the cathode slurry to an aluminum thin film having a thickness of 15 μm and vacuum-drying the cathode slurry at 135 É.

In an embodiment, a coin cell was manufactured from the cathode using lithium foil as a counter electrode, a porous polyethylene membrane (Celgard 2300, thickness of 25 μm) as a separator, and an electrolyte including 1.15 M LiPF₆ in a solvent in which ethylene carbonate and ethylmethylcarbonate are mixed in a volume ratio of 3:7.

### Test Example 1. Evaluation of Crystal Structure of Cathode Active Material

### * XRD Measurement Method

X-ray Diffraction (XRD) measurement (using a Cu source) was performed using a Rigaku D/MAX2500V/PC high-power X-ray diffraction (HP-XRD) system under conditions of 15° to 85°. After the above-described cathodes obtained in the charged state were washed with dimethyl carbonate (DMC) in a glove box, XRD measurement of the respective cathodes was performed.

### XRD Peak When Initially Charged

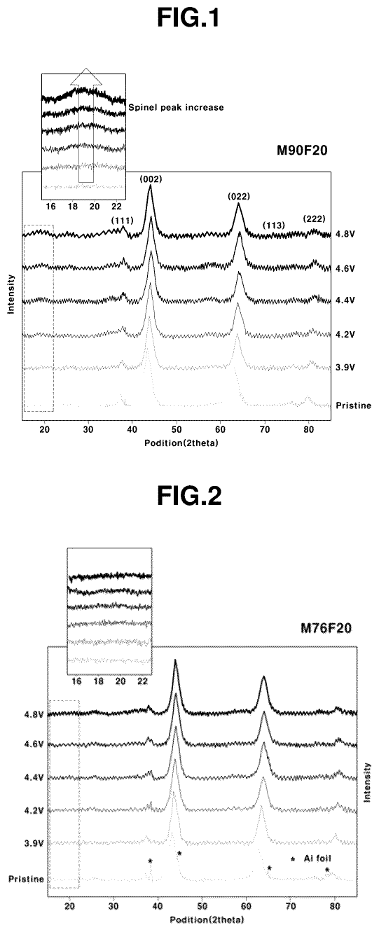

To detect the crystal structures of the cathode active materials according to Examples, X-ray diffraction patterns were measured by charging the lithium secondary batteries including the cathode active materials according to Example 1 and Example 2 at different voltages. Test results are shown in FIGS. 1 and 2.

Referring to the graph shown in FIG. 1, in the cathode active material according to Example 1, a (111) peak derived from the spinel-like structure may be observed at a diffraction angle 2θ of 18° to 19° when charging at all voltages. Thereby, it may be confirmed that phase transformation of the cathode active material according to Example 1 from the DRX structure into the spinel-like structure occurred when charging. Further, it is confirmed that, as a charging voltage increases, the intensity of the peak increases.

Referring to the graph shown in FIG. 2, in the cathode active material according to Example 2, a (111) peak derived from the spinel-like structure may be observed at a diffraction angle 2θ of 18° to 19° when charging at voltages of 4.6 V and 4.8 V. Thereby, it may be confirmed that phase transformation of the cathode active material according to Example 2 from the DRX structure into the spinel-like structure occurred when charging.

### XRD Peak due to Repetitions of Charge-Discharge Cycle

### * XRD Measurement Method

X-ray Diffraction (XRD) measurement (using a Cu source) was performed using the Rigaku D/MAX2500V/PC high-power X-ray diffraction (HP-XRD) system under conditions of 15-85°. After the above-described cathodes obtained in the charged state were washed with dimethyl carbonate (DMC) in the glove box, XRD measurement of the respective cathodes was performed.

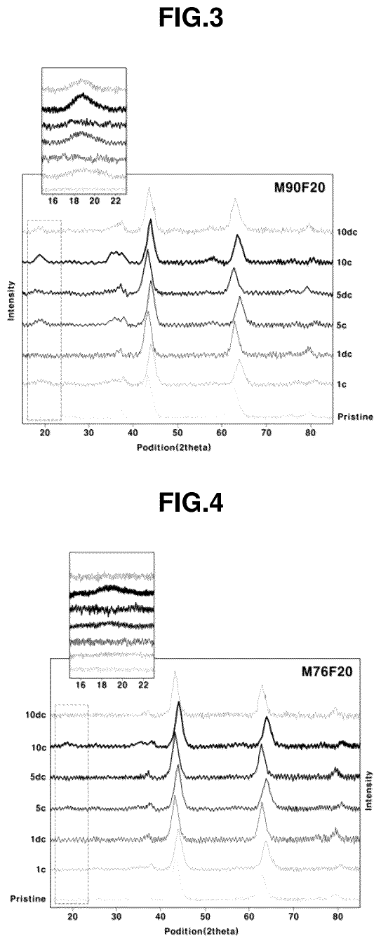

To find out whether or not phase transformation of the lithium oxide from the DRX structure into the spinel-like structure includes irreversible phase transformation, X-ray diffraction patterns were measured by repeating the charge-discharge cycle for the lithium secondary batteries including the cathode active materials according to Example 1 and Example 2. Test results are shown in FIGS. 3 and 4.

Referring to the graph shown in FIG. 3, it may be confirmed that, in the cathode active material according to Example 1, the intensity of the (111) peak derived from the spinel-like structure, observed at the diffraction angle 2θ of 18° to 19°, is increased when charging and is then decreased in the discharging process.

However, the peak is observed even after discharging after the 5th cycle, and thereby, it may be confirmed that the phase transformation of the lithium oxide according to Example 1 from the DRX structure into the spinel-like structure includes irreversible phase transformation.

Referring to the graph shown in FIG. 4, it may be confirmed that, in the cathode active material according to Example 2, the intensity of the (111) peak derived from the spinel-like structure, observed at the diffraction angle 2θ of 18° to 19°, is increased when charging and is then decreased in the discharging process.

In the cathode active material according to Example 2, the peak was not observed after discharging although the number of repetitions of the charge-discharge cycle was increased, and thereby, it may be confirmed that the lithium oxide phase-transformed from the DRX structure into the spinel-like structure in the charging process is phase-transformed again into the DRX structure in the discharging process. That is, it may be confirmed that the phase transformation of the lithium oxide according to Example 2 from the DRX structure into the spinel-like structure is reversible phase transformation.

### Measurement of Formation Rate of Spinel-like Structure

To detect the phase transformation rates of the lithium oxides from the DRX structure into the spinel-like structure when initially charging, the phase transformation rates and states of charge (SOCs) of the respective lithium oxides were calculated using a two-phase model based on Rietveld refinement of X-ray diffraction patterns (XRD refinement). When refinement of the lithium oxide M₉₀F₂₀ and the lithium oxide M₇₆F₂₀ was performed, a space group Fm-3m was used as the DRX structure, and a space group Fd-3m was used as the spinel-like structure. An element composition ratio obtained through ICP element analysis was used during fitting, and lattice parameters were obtained while changing refinement parameters. The Pseudo-Voigt function was used. All refinement results were obtained so that R_{wp} (relating to refinement accuracy) is less than 10. Test results are set forth in Table 1 below.

TABLE 1

| | Example 1 (M₉₀F₂₀) | | Example 2 (M₇₆F₂₀) | |
|---|---|---|---|---|
| | Formation rate | | Formation rate | |
| | (%) | SOC (%) | (%) | SOC (%) |
| Pristine | 0 | 0 | 0 | 0 |
| 3.9 V | 3.8 | 42 | 0 | 27 |
| 4.2 V | 9.1 | 54 | 0 | 38 |
| 4.4 V | 9.6 | 73 | 0 | 53 |
| 4.6 V | 16 | 85 | 5.4 | 77 |
| 4.8 V | 20.4 | 99 | 7.5 | 84 |

As set forth in Table 1 above, it may be confirmed that, as charging voltage increases, the formation rate of the spinel-like structure increases. Further, comparing the lithium oxides according to Examples 1 and 2, it may be confirmed that the formation rate of the spinel-like structure in the lithium oxide having a larger Mn content according to Example 1 can be relatively high.

### Test Example 2. Evaluation of Electrochemical Characteristics of Lithium Secondary Battery

### Measurement of Discharge Capacity

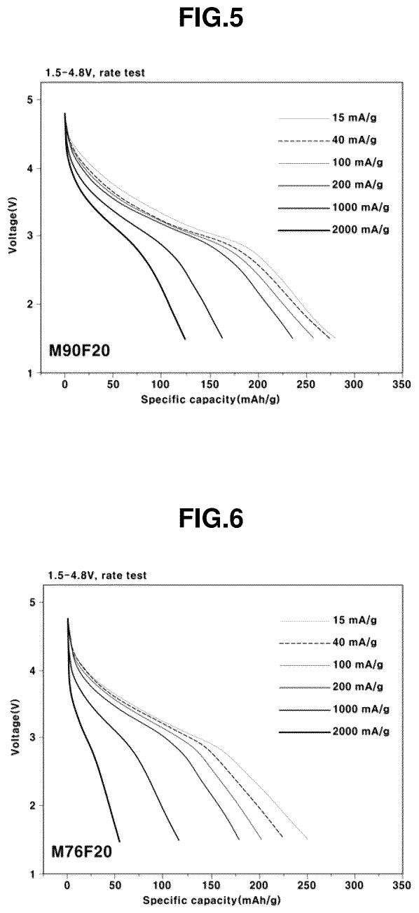

A charging and discharging test for the lithium secondary batteries including the cathode active materials according to Example 1 and Example 2 among the lithium secondary batteries manufactured according to Test Example 2 was performed in a voltage range of 1.5 V-4.8 V at a temperature of 25° C. using an electrochemical analyzer (Toyo, Toscat-3100) while changing a discharge rate. A charge rate was the same as the discharge rate. Test results are shown in FIGS. 5 and 6, and are set forth in Table 2 below.

TABLE 2

| Discharge rate | Example 1 | Example 2 | Comp. Example 1 |
|---|---|---|---|
| (mA/g) | (M₉₀F₂₀) | (M₇₆F₂₀) | (M₄₀F₀) |
| 15 | 281 | 252 | — |
| 40 | 275 | 225 | 243 |
| 100 | 259 | 203 | 200 |
| 200 | 236 | 180 | 175 |
| 1000 | 164 | 116 | 105 |
| 2000 | 125 | 55 | — |

As set forth in Table 2, in the lithium secondary batteries according to Examples 1 and 2, and Comparative Example 1, the discharge capacity tends to decrease as the discharge rate increases. Further, it may be confirmed that the discharge capacities of the lithium secondary batteries according to Example 1 and Example 2 are superior to the discharge capacity of the lithium secondary battery according to Comparative Example at all discharge rates, except that the discharge capacity of the lithium secondary battery according to Comparative Example is greater than the discharge capacity of the lithium secondary battery according to Example 2 at a discharge rate of 40 mA/g. Particularly, the discharge capacity of the lithium secondary battery according to Example 1 was measured as being greater than the discharge capacity of the lithium secondary battery according to Example 2 at all discharge rates.

Further, discharge capacity loss rates of the lithium secondary batteries according to Example 1 and Example 2 calculated through the test results measured at the discharge rates of 15 mA/g and 2000 mA/g were 55% and 78%, and discharge capacity loss rates of the lithium secondary batteries according to Example 1, Example 2, and Comparative Example 1, calculated through the test results measured at the discharge rates of 40 mA/g and 1000 mA/g, were 40.4%, 48.4%, and 56.8%. Thereby, it was confirmed that the lithium secondary batteries according to Examples can have excellent discharge capacities and rate capabilities compared to the lithium secondary battery according to Comparative Example. Particularly, the discharge capacity and the rate capability of the lithium secondary battery according to Example 1 are superior to those of the lithium secondary battery according to Example 2.

### Voltage Curve Depending on Progress of Charge-Discharge Cycle

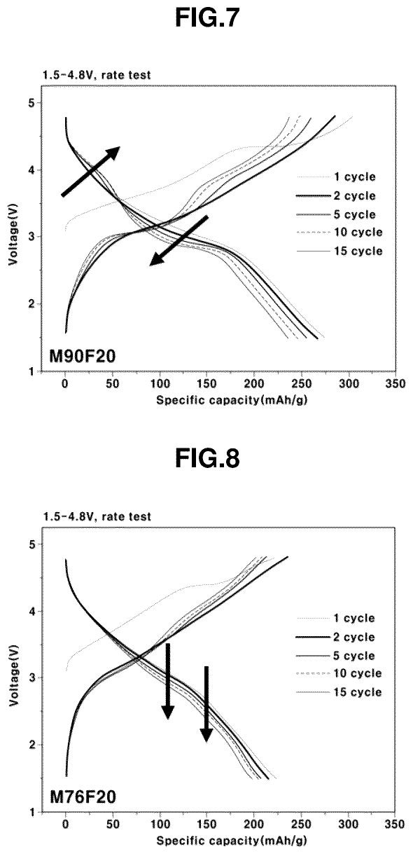

A test for the lithium secondary batteries including the cathode active materials according to Example 1 and Example 2 among the lithium secondary batteries manufactured according to Test Example 2 was performed using an electrochemical analyzer (Toyo, Toscat-3100) while repeating the charge-discharge cycle in a voltage range of 1.5 V-4.8 V at a discharge rate of 40 mA and a temperature of 25° C. Test results are shown in FIGS. 7 and 8.

Referring to FIG. 7, it may be confirmed that the cathode active material according to Example 1 exhibits flat voltage characteristics at about 3 V and about 4 V. The flat voltage characteristics are a voltage form confirmed in the spinel-like structure, and may be seen to be more prominent as the number of repetitions of the charge-discharge cycle is increased. Therefore, it may be confirmed that phase transformation of the cathode active material according to Example 1 from the DRX structure into the spinel-like structure includes irreversible phase transformation.

Referring to FIG. 8, it may be confirmed that the cathode active material according to Example 2 shows linear voltage loss. Therefore, it may be confirmed that phase transformation of the cathode active material according to Example 2 from the DRX structure into the spinel-like structure is reversible phase transformation.

### Test Example 3. Evaluation of Life Characteristics of Lithium Secondary Battery

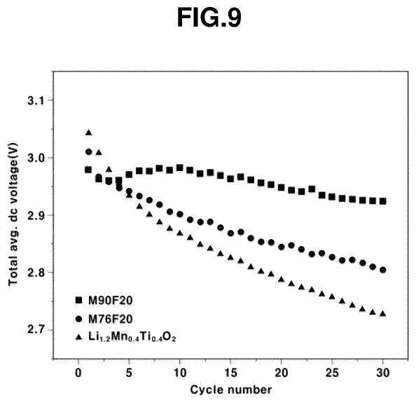

To confirm voltage conservation characteristics of the cathode active materials according to Examples, total average dc voltages of the respective cathode active materials were measured while repeating the charge-discharge cycle 30 times in a voltage range of 1.5 V-4.8 V at a discharge rate of 40 mA and a temperature of 25° C. Test results are shown in FIG. 9.

Referring to FIG. 9, as results of calculation of voltage loss rates ((V₀-V30)/V₀*100) of the respective cathode active materials using voltage in the pristine state and after the charge-discharge cycle was repeated 30 times, the voltage loss rate of the cathode active material according to Example 1 was 1.8%, the voltage loss rate of the cathode active material according to Example 2 was 5.9%, and the voltage loss rate of the cathode active material according to Comparative Example was 10.4%.

Thereby, it was confirmed that the cathode active materials according to Examples 1 and 2 in which phase transformation from the DRX structure into the spinel-like structure occurred can have excellent voltage conservation characteristics compared to the cathode active material according to Comparative Example 1 in which phase transformation did not occur.

Further, it may be confirmed that, in the cathode active material according to Comparative Example 1 and the cathode active material according to Example 2 in which reversible phase transformation occurred, discharge voltage was linearly reduced but, in the cathode active material according to Example 1 in which irreversible phase transformation was included, discharge voltage was increased in initial cycles.

As is apparent from the above description, a cathode active material according to an embodiment of the present disclosure can include a lithium oxide having a disordered rocksalt (DRX) structure, at least a part of which is phase-transformed into a spinel-like structure when charging, thereby being capable of alleviating decrease in rate capability and discharge capacity.

Particularly, the cathode active material according to an embodiment of the present disclosure may control a degree of phase transformation of the lithium oxide by adjusting the ratio of a transition metal, thereby being capable of alleviating irreversible voltage drop depending on repetitions of the charge-discharge cycle.

The present disclosure has been described in detail with reference to embodiments thereof. However, it can be appreciated by those skilled in the art that changes may be made in these embodiments without departing from the principles and spirit of the present disclosure, the scope of which is defined in the appended claims and their equivalents.

What is claimed is:

1. A cathode active material comprising:
a lithium oxide configured to enable intercalation and deintercalation of lithium;
wherein the lithium oxide is represented by Li_{1.05-x}Mn_{0.95-y}M_{y}O_{2-z}F_{z};
wherein M is at least one selected from the group consisting of Ti, Al, Nb, Mo, V, Cr, and Mg;
wherein 0≤x≤0.5, 0≤y≤0.45, and 0<z≤0.6; and
wherein the lithium oxide is configured such that:
at least a part of the lithium oxide is phase-transformed from a disordered rocksalt structure into a spinel-like structure during charging;
at least a part of the lithium oxide is phase-transformed from the spinel-like structure to the disordered rocksalt structure during discharging;
the disordered rocksalt structure and the spinel-like structure are mixed in a charged state; and
at least the disordered rocksalt structure exists in a discharged state.

2. The material of claim 1, wherein, as an amount of Mn in the lithium oxide increases, a degree of phase transformation during charging is increased.

3. The material of claim 1, wherein, a diffraction peak corresponding to a (111) plane derived from the spinel-like structure is observed in results of XRD analysis of the lithium oxide during charging.

4. The material of claim 3, wherein the diffraction peak occurs at a diffraction angle 2θ of 18° to 19°.

5. The material of claim 1, wherein y is 0.19 or less.

6. The material of claim 5, wherein the lithium oxide is configured such that, during charging and discharging of a lithium secondary battery using the cathode active material in a cathode performed under charge/discharge conditions of, in one cycle, a cut-off voltage of 1.5 V to 4.8 V, and with a constant current of 40 mA/g, voltage loss in a 30th cycle is 5.9% or less.

7. The material of claim 5, wherein, during initially charging of a lithium secondary battery using the cathode active material in a cathode at a voltage of 4.6 V, a phase transformation rate, calculated through a two-phase model based on Rietveld refinement of X-ray diffraction patterns, is 3.4% to 18%.

8. The material of claim 5, wherein a phase transformation rate from the disordered rocksalt structure into the spinel-like structure during charging is equal to or greater than a phase transformation rate from the spinel-like structure into the disordered rocksalt structure during discharging.

9. The material of claim 5, wherein the lithium oxide is Li_{1.05}Mn_{0.76} Ti_{0.19}O_{1.8}F_{0.2}.

10. The material of claim 1, wherein y is 0.05 or less.

11. The material of claim 10, wherein the lithium oxide is configured such that, during charging and discharging of a lithium secondary battery using the cathode active material in a cathode performed under charge/discharge conditions of, in one cycle, a cut-off voltage of 1.5 V to 4.8 V, and with a constant current of 40 mA/g, voltage loss in a 30th cycle is 1.8% or less.

12. The material of claim 10, wherein, during initially charging of a lithium secondary battery using the cathode active material in a cathode at a voltage of 4.6 V, a phase transformation rate, calculated through a two-phase model based on Rietveld refinement of X-ray diffraction patterns, is 14% to 18%.

13. The material of claim 10, wherein a phase transformation rate from the disordered rocksalt structure into the spinel-like structure during charging exceeds a phase transformation rate from the spinel-like structure into the disordered rocksalt structure during discharging.

14. The material of claim 10, wherein the lithium oxide is configured such that, during charging and discharging of a lithium secondary battery using the cathode active material in a cathode performed under charge/discharge conditions of, in one cycle, a cut-off voltage of 1.5 V to 4.8 V, and with a constant current of 40 mA/g, the lithium secondary battery has flat potential characteristics at 3 V and 4 V in a graph configured such that an X-axis represents specific capacity and a Y-axis represents voltage (V).

15. The material of claim 10, wherein the lithium oxide is Li_{1.05}Mn_{0.90}Ti_{0.05}O_{1.8}F_{0.2}.

16. A cathode comprising a cathode active material, wherein the cathode active material comprises a lithium oxide configured to enable intercalation and deintercalation of lithium,
wherein the lithium oxide is represented by Li_{1.05-x}Mn_{0.95-y}M_{y}O_{2-z}F_{z},
wherein M is at least one selected from the group consisting of Ti, Al, Nb, Mo, V, Cr, and Mg, and
wherein 0≤x≤0.5, 0≤y≤0.45, and 0<z≤0.6, and
wherein the lithium oxide is configured such that:
at least a part of the lithium oxide is phase-transformed from a disordered rocksalt structure into a spinel-like structure during charging,
at least a part of the lithium oxide is phase-transformed from the spinel-like structure to the disordered rocksalt structure during discharging,
the disordered rocksalt structure and the spinel-like structure are mixed in a charged state, and
at least the disordered rocksalt structure exists in a discharged state.

17. A lithium secondary battery comprising:
an anode;
a cathode comprising a cathode active material; and
an electrolyte interposed between the cathode and the anode;
wherein the cathode active material comprises a lithium oxide configured to enable intercalation and deintercalation of lithium,
wherein the lithium oxide is represented by Li_{1.05-x}Mn_{0.95-y}M_{y}O₂-2F_{z},
wherein M is at least one selected from the group consisting of Ti, Al, Nb, Mo, V, Cr, and Mg, and
wherein 0≤x≤0.5, 0≤y≤0.45, and 0<z≤0.6, and
wherein the lithium oxide is configured such that:
at least a part of the lithium oxide is phase-transformed from a disordered rocksalt structure into a spinel-like structure during charging,
at least a part of the lithium oxide is phase-transformed from the spinel-like structure to the disordered rocksalt structure during discharging,
the disordered rocksalt structure and the spinel-like structure are mixed in a charged state, and
at least the disordered rocksalt structure exists in a discharged state.

18. The battery of claim 17, wherein y is 0.19 or less.

19. The battery of claim 18, wherein the lithium oxide is Li_{1.05}Mn_{0.76} Ti_{0.19}O_{1.8}F_{0.2}.

20. The battery of claim 17, wherein y is 0.05 or less.
